(19) United States
(12) Patent Application Publication
(10) Pub. No.: US 2013/0143192 A1
(43) Pub. Date: Jun. 6, 2013

(54) METHOD FOR CALCULATING STUDENTS' TIME SPENT ANSWERING QUESTIONS IN AN ON-LINE HOMEWORK SYSTEM

(71) Applicants: John Risley, Raleigh, NC (US); Roger Booth, Apex, NC (US); Brian Marks, Raleigh, NC (US)

(72) Inventors: John Risley, Raleigh, NC (US); Roger Booth, Apex, NC (US); Brian Marks, Raleigh, NC (US)

(21) Appl. No.: 13/482,551

(22) Filed: May 29, 2012

Related U.S. Application Data
(60) Provisional application No. 61/490,696, filed on May 27, 2011.

(51) Int. Cl. G09B 7/00

(52) U.S. Cl. CPC G09B 7/00
USPC 434/362

(57) ABSTRACT

A computer software product and method are provided that calculate students' time spent interacting with an online homework and grading system. A computer software product and method are also provided for real-time capture of students' interactions with an online homework and grading system to produce timely updates to statistics on time spent answering questions. A computer program product and method are further provided to allow statistical data to be presented from WebAssign's online homework system without significantly increasing the IO requirements of the application database server.

### CROSS REFERENCE TO RELATED PATENT APPLICATION

This application claims priority to U.S. Provisional Application No. 61/490,696 filed May 27, 2011, herein incorporated by reference in its entirety.

### SUMMARY

A computer software product and method are provided that calculate students' time spent interacting with an online homework and grading system. A computer software product and method are also provided for real-time capture of students' interactions with an online homework and grading system to produce timely updates to statistics on time spent answering questions. A computer program product and method are further provided to allow statistical data to be presented from an online homework system without significantly increasing the IO requirements of the application database server.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 is a flowchart illustrating an exemplary method; and

FIG. 3 illustrates exemplary data tables.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

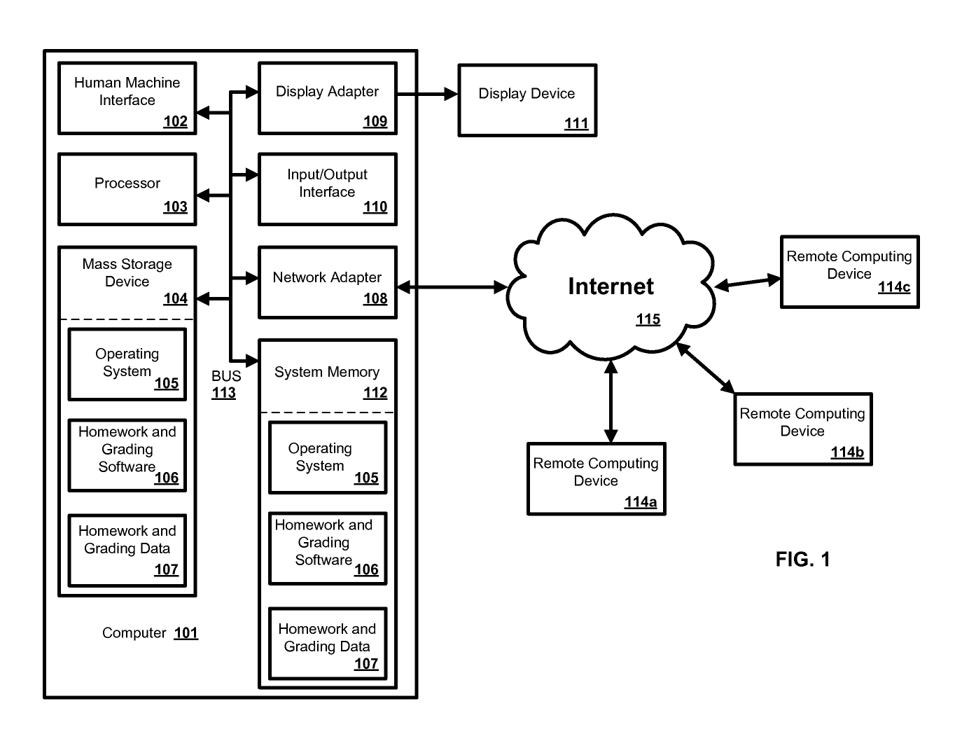

One skilled in the art will appreciate that provided is a functional description and that respective functions can be performed by software, hardware, or a combination of software and hardware. In one exemplary aspect, the methods and systems can comprise a computer 101 as illustrated in FIG. 1 and described below.

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, homework and grading software 106, homework and grading data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as homework and grading data 107 and/or program modules such as operating system 105 and homework and grading software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and homework and grading software 106. Each of the operating system 105 and homework and grading software 106 (or some combination thereof) can comprise elements of the programming and the homework and grading software 106. Homework and grading data 107 can also be stored on the mass storage device 104. Homework and grading data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of homework and grading software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

A computer software product and method are provided that calculate students' time spent answering questions in an online homework and grading system. A computer software product and method are also provided for real-time capture of students' interactions with an online homework and grading system to produce timely updates to statistics on time spent answering questions. A computer program product and method are further provided to allow statistical data to be presented from an online homework system without significantly increasing the IO requirements of the application database server.

In an aspect, a plurality of database tables can be used for recording a student's interactions within an online homework system. For example, two primary tables can be used. A first table can can comprise responses. The responses table can record an attempt number (rnum) and correctness (correct) for each answer submitted by a student. In an aspect, records in the responses table can be referenced by student_id, assignment_id, and/or question_part_id. A second table can comprise log info. The log info table can record an interaction type (def) and a timestamp (t1) for each student interaction, such as, download, save, and/or submission. In an aspect, records in the log info table can be associated with responses by student_id, assignment_id, and/or question_part_id. In an aspect, there can be more log info records than response records, and not all log info records will have a question_part_id. In an aspect, the methods and systems provided can operate under the assumption that students can answer the same question in multiple, independent assignments.

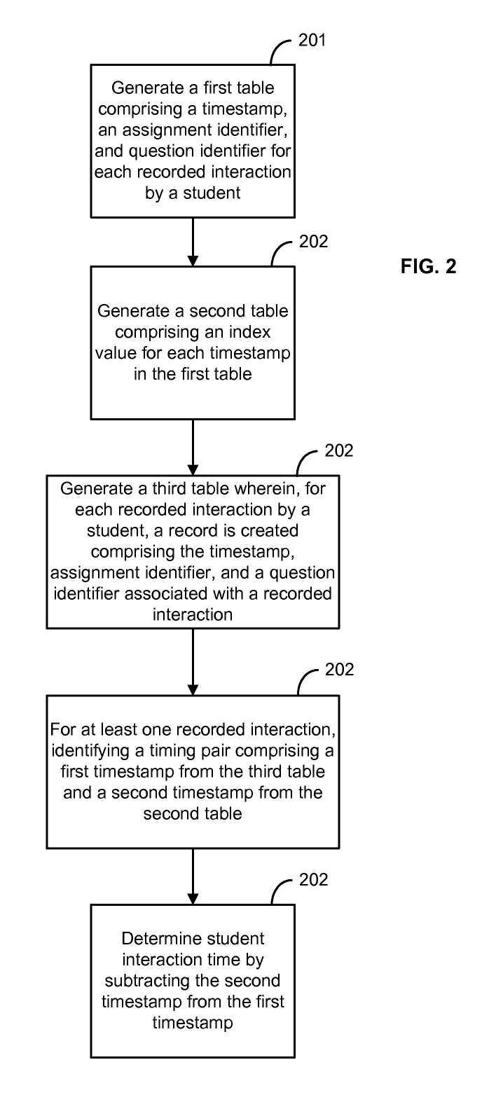

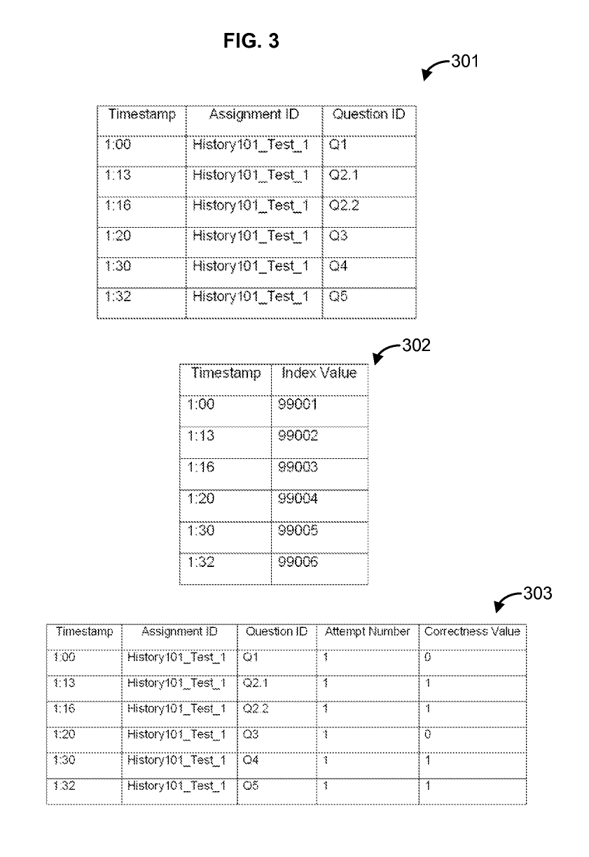

In an aspect, illustrated in FIG. 2, provided are methods for determining student interaction time, comprising generating a first table comprising a timestamp, an assignment identifier, and question identifier for each recorded interaction by a student at 201, generating a second table comprising an index value for each timestamp in the first table at 202, generating a third table wherein, for each recorded interaction by a student, a record is created comprising the timestamp, assignment identifier, and question identifier associated with a recorded interaction at 203, for at least one recorded interaction, identifying a timing pair comprising a first timestamp from the third table and a second timestamp from the second table at 204, and determining student interaction time by subtracting the second timestamp from the first timestamp at 205. In an aspect, the third table can further comprise an attempt number and/or a correctness value. An exemplary first table is shown in FIG. 3 at 301, an exemplary second table is shown in FIG. 3 at 302, and an exemplary third table is shown in FIG. 3 at 303.

The recorded interaction can comprise one or more of a download, an answer submission, and a save interaction. The question identifier can identify a part of a multi-part question. Determining student interaction time by subtracting the second timestamp from the first timestamp can comprise identifying a number of occurrences of the first time stamp in the third table and dividing the student interaction time by the number of occurrences.

Identifying a timing pair can comprises locating a first index value associated with the first timestamp in the second table, identifying a second index value by decrementing the first index value, and identifying the timestamp associated with the second index value as the second timestamp.

Generating the first table can comprise analyzing a replication stream of real-time student interaction and extracting data for insertion into the first table and the third table from the replication stream in real-time.

Extracting data can comprise identifying SQL statements in the replication stream, parsing the SQL statements to identify insert SQL statements, and extracting data from the identified insert SQL statements.

The methods can be performed on an online transaction processing system and utilizing an online analytics processing system to access the online transaction processing system to generate statistical data related to student interaction.

Data can be processed to produce median and mean values of time spent answering questions. Different levels of aggregation can be applied: question part, question, assignment, class, etc. In an aspect, distribution of the data by time interval can be used to produce histograms.

We make classroom-specific and assignment-specific statistics can be generated and made available to instructors and students. To reduce I/O requirements for storing these data in a primary database server, the associated tables can be populated as needed from a secondary data storage system that maintains the data in a highly compressed form.

An On Line Transaction Processing (OLTP) database can be used to record interactions with students and instructors. This OLTP system allows high concurrency and provides redundancy in case of hardware failure. The disclosed methods and systems can use a secondary On Line Analytics Processing (OLAP) system for storage and processing of statistical data, including data derived from the disclosed methods. The OLAP system can provide a facility for receiving parameterized requests from an external source and can execute arbitrary programs based on the received parameters and data contained within the OLAP system.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for determining student interaction time, comprising:
generating a first table comprising a timestamp, an assignment identifier, and question identifier for each recorded interaction by a student;
generating a second table comprising an index value for each timestamp in the first table;
generating a third table wherein, for each recorded interaction by a student, a record is created comprising the timestamp, assignment identifier, a question identifier, an attempt number, and a correctness value associated with a recorded interaction;
for at least one recorded interaction, identifying a timing pair comprising a first timestamp from the third table and a second timestamp from the second table; and
determining student interaction time by subtracting the second timestamp from the first timestamp.

2. The method of claim 1, wherein the recorded interaction comprises one or more of a download, an answer submission and a save interaction.

3. The method of claim 1, wherein the question identifier identifies a part of a multi-part question.

4. The method of claim 3, wherein determining student interaction time by subtracting the second timestamp from the first timestamp comprises:
identifying a number of occurrences of the first time stamp in the third table; and
dividing the student interaction time by the number of occurrences.

5. The method of claim 1, wherein identifying a timing pair comprises:
locating a first index value associated with the first timestamp in the second table;
identifying a second index value by decrementing the first index value; and
identifying the timestamp associated with the second index value as the second timestamp.

6. The method of claim 1, wherein generating the first table comprises:
analyzing a replication stream of real-time student interaction; and
extracting data for insertion into the first table and the third table from the replication stream in real-time.

7. The method of claim 6, wherein extracting data comprises:
identifying SQL statements in the replication stream;
parsing the SQL statements to identify insert SQL statements; and
extracting data from the identified insert SQL statements.

8. The method of claim 1, further comprising performing the steps of claim 1 on an online transaction processing system and utilizing an online analytics processing system to access the online transaction processing system to generate statistical data related to student interaction.

9. A system for determining student interaction time, comprising:
a memory; and
a processor, coupled to the memory, configured for performing steps comprising,
generating a first table comprising a timestamp, an assignment identifier, and question identifier for each recorded interaction by a student;
generating a second table comprising an index value for each timestamp in the first table;
generating a third table wherein, for each recorded interaction by a student, a record is created comprising the timestamp, assignment identifier, a question identifier, an attempt number, and a correctness value associated with a recorded interaction;
for at least one recorded interaction, identifying a timing pair comprising a first timestamp from the third table and a second timestamp from the second table; and
determining student interaction time by subtracting the second timestamp from the first timestamp.

10. The system of claim 9, wherein the recorded interaction comprises one or more of a download, an answer submission, and a save interaction.

11. The system of claim 9, wherein the question identifier identifies a part of a multi-part question.

12. The system of claim 11, wherein determining student interaction time by subtracting the second timestamp from the first timestamp comprises:
identifying a number of occurrences of the first time stamp in the third table; and
dividing the student interaction time by the number of occurrences;

13. The system of claim 9, wherein identifying a timing pair comprises:
locating a first index value associated with the first timestamp in the second table;
identifying a second index value by decrementing the first index value; and
identifying the timestamp associated with the second index value as the second timestamp.

14. The system of claim 9, wherein generating the first table comprises:
analyzing a replication stream of real-time student interaction; and
extracting data for insertion into the first table and the third table from the replication stream in real-time.

15. The system of claim 14, wherein extracting data comprises:
identifying SQL statements in the replication stream;
parsing the SQL statements to identify insert SQL statements; and
extracting data from the identified insert SQL statements.

16. The system of claim 9, further comprising performing the steps of claim 1 on an online transaction processing system and utilizing an online analytics processing system to access the online transaction processing system to generate statistical data related to student interaction.

17. A computer readable medium having computer executable instructions embodied thereon for determining student interaction time, the computer executable instructions comprising:
generating a first table comprising a timestamp, an assignment identifier, and question identifier for each recorded interaction by a student;
generating a second table comprising an index value for each timestamp in the first table;
generating a third table wherein, for each recorded interaction by a student, a record is created comprising the timestamp, assignment identifier, a question identifier, an attempt number, and a correctness value associated with a recorded interaction;
for at least one recorded interaction, identifying a timing pair comprising a first timestamp from the third table and a second timestamp from the second table; and
determining student interaction time by subtracting the second timestamp from the first timestamp.

18. The computer readable medium of claim 17, wherein determining student interaction time by subtracting the second timestamp from the first timestamp comprises:
identifying a number of occurrences of the first time stamp in the third table; and
dividing the student interaction time by the number of occurrences;

19. The computer readable medium of claim 17, wherein identifying a timing pair comprises:
locating a first index value associated with the first timestamp in the second table;
identifying a second index value by decrementing the first index value; and
identifying the timestamp associated with the second index value as the second timestamp.

20. The computer readable medium of claim 17, wherein generating the first table comprises:
analyzing a replication stream of real-time student interaction; and
extracting data for insertion into the first table and the third table from the replication stream in real-time.
